(19) United States
(12) Patent Application Publication
(10) Pub. No.: US 2024/0272328 A1
(43) Pub. Date: Aug. 15, 2024

(54) MONITORING THE SPRAYING OF PARTICLES INTO THE STRATOSPHERE TO ADDRESS GLOBAL WARMING USING SMARTPHONES

(71) Applicant: Mobile Physics Ltd., Kfar Saba (IL)

(72) Inventor: Erez WEINROTH, Kfar Saba (IL)

(73) Assignee: Mobile Physics Ltd., Kfar Saba (IL)

(21) Appl. No.: 18/645,973

(22) Filed: Apr. 25, 2024

Related U.S. Application Data
(63) Continuation of application No. PCT/IL2022/051127, filed on Oct. 26, 2022.
(60) Provisional application No. 63/271,741, filed on Oct. 26, 2021.

(51) Int. Cl. G01W 1/10; A01G 15/00

(52) U.S. Cl. CPC G01W 1/10; A01G 15/00; G01W 2201/00

(57) ABSTRACT

A method and a system for monitoring the spraying of sunlight reflecting particles into the stratosphere to address global warming using smartphones are provided herein. The method may include the following steps: spraying, using a plurality of airplanes flying through a plurality of different geographical locations, sunlight reflecting particles, in accordance with a spraying scheme; sampling using sensors of a plurality of smartphones located in a plurality of different geographical locations, a plurality of atmospheric measurements; training, using a computer processor, and based on the plurality of atmospheric measurements, a model configured to predict a trend in a change of temperature in consequence of the spraying of the sunlight reflecting particles; and repeatedly updating the spraying scheme based on the model.

### CROSS REFERENCE TO RELATED APPLICATION

This application is a Continuation application of PCT Application No. PCT/IL2022/051127 filed Oct. 26, 2022, claiming priority from U.S. Provisional Patent Application No. 63/271,741 filed Oct. 26, 2021, both are incorporated herein by reference in their entirety.

### FIELD OF THE INVENTION

The present invention relates generally to the field of geoengineering, and more particularly to monitoring, using smartphones, the effect achieved by spraying of sun-reflecting particles into the stratosphere, to address global warming.

### BACKGROUND OF THE INVENTION

The idea of cooling down the planet by spraying sun-reflecting particles into the stratosphere is known in the art. These particles serve as radiation filters which block some of the sunlight and effectively reduce the average temperature of the atmosphere.

Implementing this idea is very challenging and far from trivial. Apart from the complicated logistics involved in orchestrating a huge fleet of airplanes that can spray these particles, it is desirable to monitor the effect of the process of the sprayed particles on the temperature in many locations simultaneously to avoid over-cooling.

There is a need therefore for monitoring the temperature and other atmospheric parameters in millions of geographical locations and deducing trends of temperature change.

### SUMMARY OF THE INVENTION

Some embodiments of the present invention provide a method and a system for monitoring the spraying of sunlight reflecting particles into the stratosphere to address global warming using smartphones. The method may include the following steps: spraying, using a plurality of airplanes flying through a plurality of different geographical locations, sunlight reflecting particles, in accordance with a spraying scheme; sampling using sensors of a plurality of smartphones located in a plurality of different geographical locations, a plurality of atmospheric measurements; training, using a computer processor, and based on the plurality of atmospheric measurements, a model configured to predict a trend in a change of temperature in consequence of the spraying of the sunlight reflecting particles; and repeatedly updating the spraying scheme based on the model.

The system may implement the method using a plurality of smartphones connected to a computer processor over a cloud, using a dedicated application that controls the various sensors which are built in the smartphones or are implemented using a dedicated software thereon.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating an environment of a system in accordance with embodiments of the present invention;

FIG. 2 is a block diagram illustrating an architecture of a system in accordance with embodiments of the present invention; and

FIG. 3 is a high-level flowchart illustrating a method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

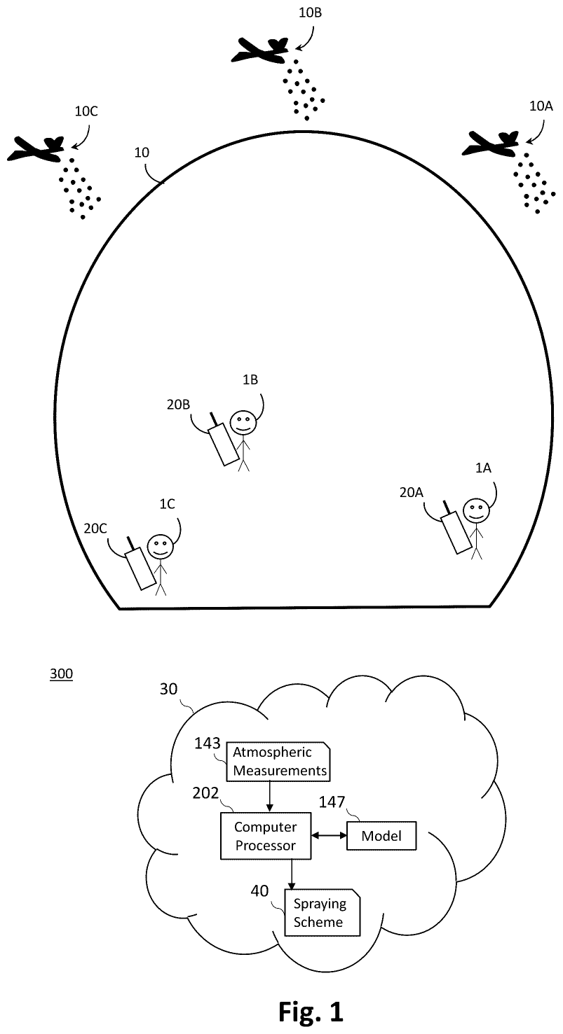

FIG. 1 is a block diagram illustrating an environment of a system in accordance with some embodiments of the present invention; System 100 may include a plurality of airplanes 10A-10C flying through a plurality of different geographical locations, configured to spray sunlight reflecting particles, in accordance with a spraying scheme 40. System 100 may further include a plurality of smartphones 20A-20C associated with users 1A-1C located in a plurality of different geographical locations and configured to sample using sensors thereof, a plurality of atmospheric measurements 143.

According to some embodiments of the present invention, system 100 may further include a computer processor 202 possibly within a server implemented on a cloud 30 and configured to: train, based on the plurality of atmospheric measurements 143, a model 147 configured to predict a trend in a change of temperature in consequence of the spraying of the sunlight reflecting particles; and repeatedly update the spraying scheme 40 based on the model 147 so it can be used to orchestrate the flying schedule and spraying of plurality of airplanes 10A-10C.

According to some embodiments of the present invention, the computer processor is further configured to monitor the flying airplanes and to ensure the spraying is carried out based on the updated model.

According to some embodiments of the present invention, the computer processor is further configured to visually presenting over a display of at least some of the smartphones, the trend in a change of temperature in consequence of the spraying of the sunlight reflecting particles.

According to some embodiments of the present invention, the sensors of the smartphone include at least one microphone and speaker configured to determine, using the computer processor of the smartphone: temperature, humidity, and particle density in proximity of the smartphone.

According to some embodiments of the present invention, the sensors of the smartphone include a Light Detection and Ranging o Laser (LIDAR) configured to determine, using the computer processor of the smartphone: temperature, humidity, and particle density in proximity of the smartphone.

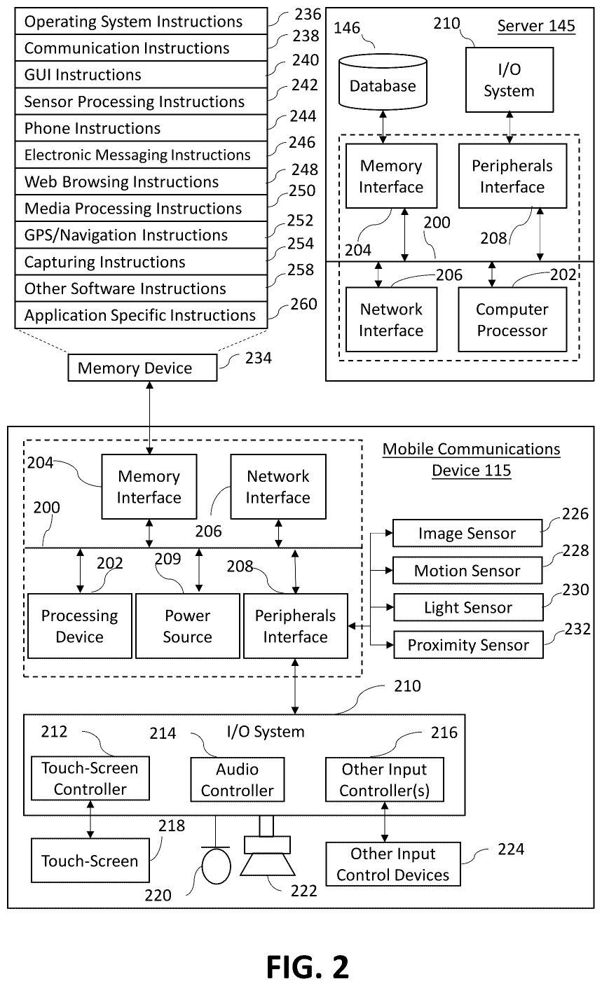

FIG. 2 is a block diagram illustrating an architecture of a system in accordance with embodiments of the present invention. FIG. 2 is an exemplary block diagram of configurations of server 145 and mobile communications device 115. In one embodiment, server 145 and mobile communications device 115 directly or indirectly accesses a bus 200 (or other communication mechanism) that interconnects subsystems and components for transferring information within server 145 and/or mobile communications device 115. For example, bus 200 may interconnect a processing device 202, a memory interface 204, a network interface 206, a peripherals interface 208 connected to I/O system 210, and power source 209.

Processing device 202, shown in FIG. 2, may include at least one processor configured to execute computer programs, applications, methods, processes, or other software to perform embodiments described in the present disclosure. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™. The processing device may include a single core or multiple core processors executing parallel processes simultaneously. In one example, the processing device may be a single core processor configured with virtual processing technologies. The processing device may implement virtual machine technologies or other technologies to provide the ability to execute, control, run, manipulate, store, etc., multiple software processes, applications, programs, etc. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, server 145 may use memory interface 204 to access data structure 146. As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within mobile communications device 115, server 145, or at a remote location. Additionally, one or more computer-readable storage mediums can be utilized in implementing a computer-implemented method. The term “computer-readable storage medium” should be understood to include tangible items and exclude carrier waves and transient signals.

Both mobile communications device 115 and server 145 may include network interface 206 coupled to bus 200. Network interface 206 may provide two-way data communications to a network, such as network 150. In FIG. 2, the wireless communication between mobile communications device 115 and server 145 is represented by a dashed arrow. In one embodiment, network interface 206 may include an integrated services digital network (ISDN) card, cellular modem, satellite modem, or a modem to provide a data communication connection over the Internet. As another example, network interface 206 may include a wireless local area network (WLAN) card. In another embodiment, network interface 206 may include an Ethernet port connected to radio frequency receivers and transmitters and/or optical (e.g., infrared) receivers and transmitters. The specific design and implementation of network interface 206 may depend on the communications network(s) over which mobile communications device 115 and server 145 are intended to operate. For example, in some embodiments, mobile communications device 115 may include network interface 206 designed to operate over a GSM network, a GPRS network, 3G, LTE, 5G, an EDGE network, a Wi-Fi network, and a Bluetooth® network. In any such implementation, network interface 206 may be configured to send and receive electrical, electromagnetic, or optical signals that carry digital data streams representing various types of information.

Both mobile communications device 115 and server 145 may also include peripherals interface 208 coupled to bus 200. Peripherals interface 208 may be connected to sensors, devices, and subsystems to facilitate multiple functionalities. In one embodiment, peripherals interface 208 may be connected to I/O system 210 configured to receive signals or input from devices and to provide signals or output to one or more devices that allow data to be received and/or transmitted by mobile communications device 115 and server 145. In one example, I/O system 210 may include a touch screen controller 212, audio controller 214, and/or other input controller(s) 216. Touch screen controller 212 may be coupled to a touch screen 218. Touch screen 218 and touch screen controller 212 may, for example, detect contact, movement or break thereof using any of a plurality of touch sensitivity technologies, including but not limited to capacitive, resistive, infrared, and surface acoustic wave technologies as well as other proximity sensor arrays or other elements for determining one or more points of contact with the touch screen 218. Touch screen 218 may also, for example, be used to implement virtual or soft buttons and/or a keyboard. While touch screen 218 is shown in FIG. 2, I/O system 210 may include a display screen (e.g., CRT or LCD) in place of touch screen 218. Audio controller 214 may be coupled to a microphone 220 and a speaker 222 to facilitate voice-enabled functions, such as voice recognition, voice replication, digital recording, and telephony functions. The other input controller(s) 216 may be coupled to other input/control devices 224, such as one or more buttons, rocker switches, thumbwheel, infrared port, USB port, and/or a pointer device such as a stylus.

With regard to mobile communications device 115, peripherals interface 208 may also be connected to an image sensor 226, a motion sensor 228, a light sensor 230, and/or a proximity sensor 232 to facilitate image capturing, orientation, lighting, and proximity functions. Other sensors (not shown) may also be connected to the peripherals interface 208, such as a temperature sensor, a biometric sensor, or other sensing devices to facilitate related functionalities. In addition, a GPS receiver may also be integrated with, or connected to, mobile communications device 115, such as GPS receivers typically integrated into mobile communications devices. Alternatively, GPS software may permit a mobile communications device to access AN external GPS receiver (e.g., connecting via a serial port or Bluetooth).

Consistent with the present disclosure, mobile communications device 115 may use memory interface 204 to access memory device 234. Memory device 234 may include high-speed random-access memory and/or non-volatile memory such as one or more magnetic disk storage devices, one or more optical storage devices, and/or flash memory (e.g., NAND, NOR). Memory device 234 may store an operating system 236, such as DARWIN, RTXC, LINUX, iOS, UNIX, OSX, WINDOWS, or an embedded operating system such as VxWorks. Operating system 236 may include instructions for handling basic system services and for performing hardware-dependent tasks. In some implementations, the operating system 236 may be a kernel (e.g., UNIX kernel).

Memory device 234 may also store communication instructions 238 to facilitate communicating with one or more additional devices, one or more computers and/or one or more servers. Memory device 234 may include: graphical user interface instructions 240 to facilitate graphic user interface processing; sensor processing instructions 242 to facilitate sensor-related processing and functions; phone instructions 244 to facilitate phone-related processes and functions; electronic messaging instructions 246 to facilitate electronic-messaging related processes and functions; web browsing instructions 248 to facilitate web browsing-related processes and functions; media processing instructions 250 to facilitate media processing-related processes and functions; GPS/navigation instructions 252 to facilitate GPS and navigation-related processes and instructions; capturing instructions 254 to facilitate processes and functions related to image sensor 226; and/or other software instructions 258 to facilitate other processes and functions. Memory device 234 may also include application specific instructions 260 to facilitate a process for guiding user 110 on the steps of the medical testing. For example, application specific instructions 260 may cause display of a massage indicative of image insufficiency for medical testing.

Each of the above identified instructions and applications may correspond to a set of instructions for performing one or more functions described above. These instructions need not be implemented as separate software programs, procedures, or modules. Memory device 234 may include additional instructions or fewer instructions. Furthermore, various functions of mobile communications device 115 may be implemented in hardware and/or in software, including in one or more signal processing and/or application specific integrated circuits. For example, mobile communications device 115 may execute an image processing algorithm to identify objects in a received image. In addition, the components and arrangements shown in FIG. 2 are not intended to limit the disclosed embodiments. As will be appreciated by a person skilled in the art having the benefit of this disclosure, numerous variations and/or modifications may be made to the depicted configuration of server 145. For example, not all components may be essential for the operation of server 145 in all cases. Any component may be located in any appropriate part of server 145, and the components may be rearranged into a variety of configurations while providing the functionality of the disclosed embodiments. For example, some servers may not include all the elements in I/O system 210.

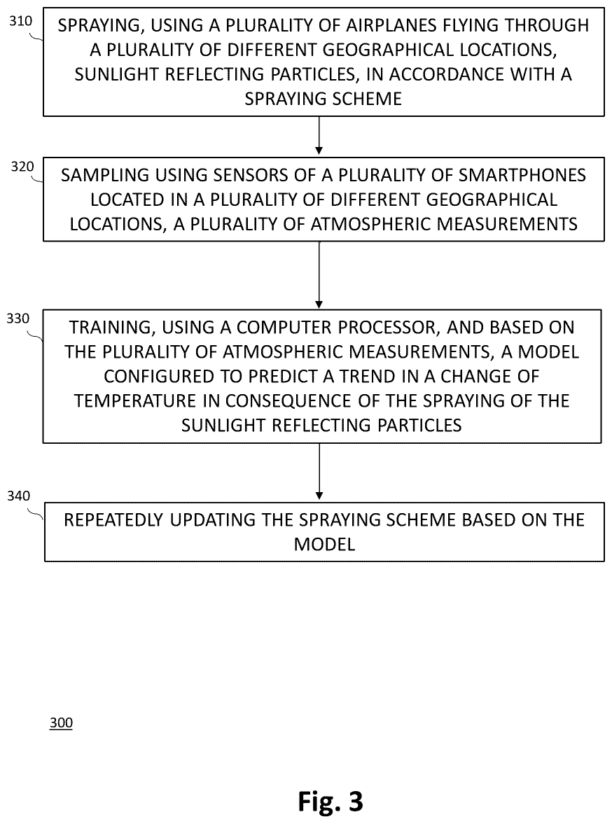

FIG. 3 is a high-level flowchart illustrating a method in accordance with embodiments of the present invention. Method 300 for monitoring the spraying of sunlight reflecting particles into the stratosphere to address global warming using smartphones is illustrated herein. Method 300 may include the following steps: spraying, using a plurality of airplanes flying through a plurality of different geographical locations, sunlight reflecting particles, in accordance with a spraying scheme 310; sampling using sensors of a plurality of smartphones located in a plurality of different geographical locations, a plurality of atmospheric measurements 320; training, using a computer processor, and based on the plurality of atmospheric measurements, a model configured to predict a trend in a change of temperature in consequence of the spraying of the sunlight reflecting particles 330; and repeatedly updating the spraying scheme based on the model 340.

It should be noted that method 300 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
spraying, using a plurality of airplanes flying through a plurality of different geographical locations, sunlight reflecting particles, in accordance with a spraying scheme;
sampling using sensors of a plurality of smartphones located in a plurality of different geographical locations, a plurality of atmospheric measurements;
training, using a computer processor, and based on the plurality of atmospheric measurements, a model configured to predict a trend in a change of temperature in consequence of the spraying of the sunlight reflecting particles; and
repeatedly updating the spraying scheme based on the model.

2. The method according to claim 1, further comprising monitoring the flying airplanes and ensuring the spraying is carried out based on the updated model.

3. The method according to claim 1, further comprising visually presenting the trend in a change of temperature in consequence of the spraying of the sunlight reflecting particles on at least some of the smartphones.

4. The method according to claim 1, wherein the sensors of the smartphone include at least one microphone and speaker configured to determine, using the computer processor of the smartphone: temperature, humidity, and particle density in proximity of the smartphone.

5. The method according to claim 1, wherein the sensors of the smartphone include a Light Detection and Ranging o Laser (LIDAR) configured to determine, using the computer processor of the smartphone: temperature, humidity, and particle density in proximity of the smartphone.

6. A system comprising:
a plurality of airplanes flying through a plurality of different geographical locations, configured to spray sunlight reflecting particles, in accordance with a spraying scheme;
a plurality of smartphones located in a plurality of different geographical locations and configured to sample using sensors thereof, a plurality of atmospheric measurements; and
a computer processor configured to: train, based on the plurality of atmospheric measurements, a model configured to predict a trend in a change of temperature in consequence of the spraying of the sunlight reflecting particles; and repeatedly update the spraying scheme based on the model.

7. The system according to claim 6, wherein the computer processor is further configured to monitor the flying airplanes and to ensure the spraying is carried out based on the updated model.

8. The system according to claim 6, wherein the computer processor is further configured to visually present over a display of at least some of the smartphones, the trend in a change of temperature in consequence of the spraying of the sunlight reflecting particles.

9. The system according to claim 6, wherein the sensors of the smartphone include at least one microphone and speaker configured to determine, using the computer processor of the smartphone: temperature, humidity, and particle density in proximity of the smartphone.

10. The system according to claim 6, wherein the sensors of the smartphone include a Light Detection and Ranging o Laser (LIDAR) configured to determine, using the computer processor of the smartphone: temperature, humidity, and particle density in proximity of the smartphone.

11. A non-transitory computer readable medium for monitoring a spraying of particles by airplanes into the stratosphere based on a spraying scheme, the computer readable medium comprising a set of instructions that, when executed, cause at least one computer processor to:
obtain a plurality of atmospheric measurements from sensors located on a plurality of smartphones located in a plurality of different geographical locations;
train, based on the plurality of atmospheric measurements, a model configured to predict a trend in a change of temperature in consequence of the spraying of the sunlight reflecting particles; and
repeatedly update the spraying scheme based on the model.

12. The non-transitory computer readable medium according to claim 11, further comprising a set of instructions that, when executed, cause the at least one computer processor to monitor the flying airplanes and to ensure the spraying is carried out based on the updated model.

13. The non-transitory computer readable medium according to claim 11, further comprising a set of instructions that, when executed, cause the at least one computer processor to visually present over a display of at least some of the smartphones, the trend in a change of temperature in consequence of the spraying of the sunlight reflecting particles.

14. The non-transitory computer readable medium according to claim 11, further comprising a set of instructions that, when executed, cause the at least one computer processor to collect signals from at least one microphone and at least one speaker of the smartphones and calculate temperature, humidity, and particle density in proximity of the smartphones.

15. The non-transitory computer readable medium according to claim 11, further comprising a set of instructions that, when executed, cause the at least one computer processor to collect signals from a Light Detection and Ranging o Laser (LIDAR) installed on the smartphones, and calculate at least one of: temperature, humidity, and particle density in proximity of the smartphones.
